(19) United States
(12) Patent Application Publication
(10) Pub. No.: US 2004/0256474 A1
(43) Pub. Date: Dec. 23, 2004

(54) Indoor environmental control system and method of controlling the same

(75) Inventors: Ki-cheol Park, Hwasung city (KR); Yeon-taek Oh, Yongin city (KR); Won-jun Koh, Suwon city (KR); Yong-jae Kim, Seoul city (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 10/814,283

(22) Filed: Apr. 1, 2004

(30) Foreign Application Priority Data
Jun. 23, 2003 (KR) 2003-40847

(51) Int. Cl. G05D 23/00

(52) U.S. Cl. 236/51

(57) ABSTRACT

An indoor environmental control system having an indoor environmental control device to control at least one indoor environment, including a mobile sensor being movable, and a wireless transmitting/receiving part to wirelessly transmit/receive information, an indoor environmental sensor to sense the indoor environment, and a controller to transmit the information on the indoor environment sensed by the indoor environmental sensor through the wireless transmitting/receiving part; and a control server receiving the information transmitted from the mobile sensor so as to control the indoor environmental control device on the basis of the received information. Therefore, the present invention provides an indoor environment control system and a method of controlling the same, which can optimize indoor environments through a home network.

### CROSS-REFERENCE TO RELATED APPLICATIONS

This application claims the benefit of Korean Patent Application No. 2003-40847 filed on Jun. 23, 2003, in the Korean Intellectual Property Office, the disclosure of which is incorporated herein by reference.

### BACKGROUND OF THE INVENTION

1. Field of the Invention

The present invention relates to an indoor environmental control system and a method of controlling the same and more particularly, to an indoor environment control system and a method of controlling the same, which can optimize indoor environments through a home network.

2. Description of the Related Art

Generally, an indoor environmental control system controls indoor environments such as temperature, humidity and air cleanness, and includes an indoor environmental device such as an air conditioner, a heater and an air cleaner. The indoor environmental device comprising a sensor to sense the indoor environments, and a controller receiving information on the sensed indoor environments and displaying the indoor environments on a display. Further, the controller controls a temperature controller and a humidity controller to change the indoor environments according to user settings.

Generally, the indoor environmental control device is immovably installed at a specific place in a room, so that sensing the indoor environments is limited to a predetermined area and not to the whole room. Hence, it is difficult to optimize the indoor environments.

Recently, a home network system has been designed, wherein a home server receives information on home appliances and the indoor environments from the home appliances such as the indoor environmental control device, and controls the home appliances according to user settings. In the home network system, a user may access the home server through a cellular phone, a personal digital assistant (PDA) or the like, and can set up indoor temperature, indoor humidity, the brightness of an electric light, a channel of a television and volume of audio devices as desired. Then, the home server controls the home appliances linked to a home network according to user settings.

### SUMMARY OF THE INVENTION

Accordingly, it is an aspect of the present invention to provide an indoor environment control system and a method of controlling the same, which can optimize indoor environments through a home network.

Additional aspects and advantages of the invention will be set forth in part in the description which follows and, in part, will be obvious from the description, or may be learned by practice of the invention.

The foregoing and/or other aspects of the present invention are achieved by providing an indoor environmental control system having an indoor environmental control device to control at least one indoor environment, the indoor environmental control system comprising a mobile sensor being movable, and comprising a wireless transmitting/receiving part to wirelessly transmit and receive information, an indoor environmental sensor to sense the indoor environment, and a controller to transmit the information on the indoor environment sensed by the indoor environmental sensor through the wireless transmitting/receiving part; and a control server to receive the information transmitted from the mobile sensor so as to control the indoor environmental control device based upon the received information.

The indoor environment comprising at least one of temperature, humidity, and air cleanness.

The mobile sensor further comprising a driver to move the mobile sensor.

According to an aspect of the invention, the mobile sensor further comprising a position recognizer to recognize a position of itself, wherein the controller transmits the information on the position recognized by the position recognizer and the information on the indoor environments sensed by the indoor environmental sensor to the control server through the wireless transmitting/receiving part.

According to an aspect of the invention, the control server estimates a map based upon the information on the position recognized by the position recognizer and the information on the indoor environments received from the mobile sensor, and controls the indoor environmental control device to control the indoor environments based upon the estimated map.

According to an aspect of the invention, the mobile sensor further comprising a voice recognizer to recognize a voice command of a user, and the controller controls the indoor environmental control device to control the indoor environments according to the voice command recognized by the voice recognizer.

It is another aspect of the present invention to provide a method of controlling an indoor environmental control system having an indoor environmental control device to control at least one indoor environment, the method comprising: sensing indoor environments according to positions; and controlling the indoor environmental control device to control the indoor environments based upon the indoor environments sensed.

The indoor environment comprising at least one of temperature, humidity, and air cleanness.

The method further comprising transmitting information on the indoor environments sensed according to the positions to a control server, estimating a map containing the information on the indoor environments based on the received information, and controlling the indoor environmental control device to control the indoor environments based upon the estimated map.

The method further comprising recognizing a voice command of a user, and controlling the indoor environmental control device to control the indoor environments according to the recognized voice command.

### BRIEF DESCRIPTION OF THE DRAWINGS

These and/or other aspects and advantages of the invention will become apparent and more readily appreciated from the following description of the embodiments taken in conjunction with the accompany drawings in which:

FIG. 1 schematically illustrates an indoor environmental control system according to an embodiment of the present invention;

FIG. 2 illustrates a network structure for the indoor environmental control system of FIG. 1;

FIG. 3 is a control block diagram of the indoor environmental control system according to an embodiment of the present invention;

FIG. 4 is a map containing information on indoor environments, according to an embodiment the present invention; and

FIG. 5 is a control flowchart of the indoor environmental control system according to an embodiment the present invention.

### DETAILED DESCRIPTION OF THE PREFERRED EMBODIMENTS

Reference will now be made in detail to the embodiments of the present invention, examples of which are illustrated in the accompanying drawings, wherein like reference numerals refer to like elements throughout. The embodiments are described below in order to explain the present invention by referring to the figures.

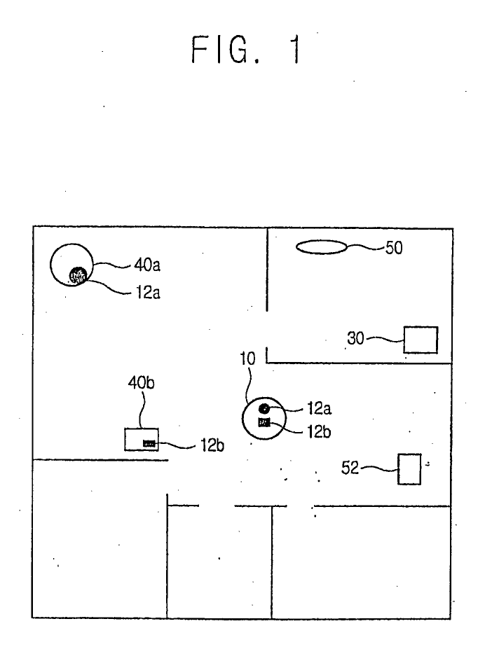

FIG. 1 schematically illustrates an indoor environmental control system according to an embodiment of the present invention. An indoor environmental control system comprising an indoor environmental device 40 comprising an air conditioner/heater unit and 40a an air cleaner 40b to control indoor environments such as temperature, humidity and air cleanness; a mobile sensor 10 comprising a temperature sensor 12a and an air cleanness sensor 12b to sense the indoor environments, and transmitting information on the sensed indoor environments to a control server 30 through a wireless network; and the control server 30 to control the indoor environmental device 40 based upon the information received from the mobile sensor 10.

The mobile sensor 10 is a mobile robot. Further, the mobile sensor 10, the indoor environmental control device 40, and the control server 30 are linked to one another through a home network.

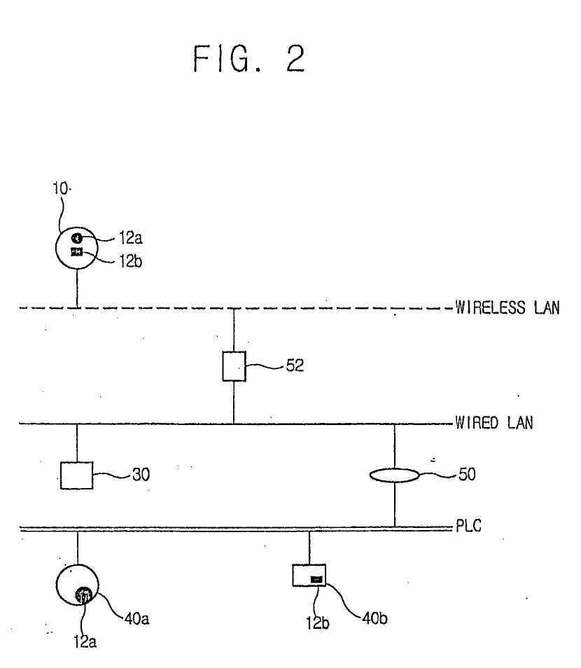

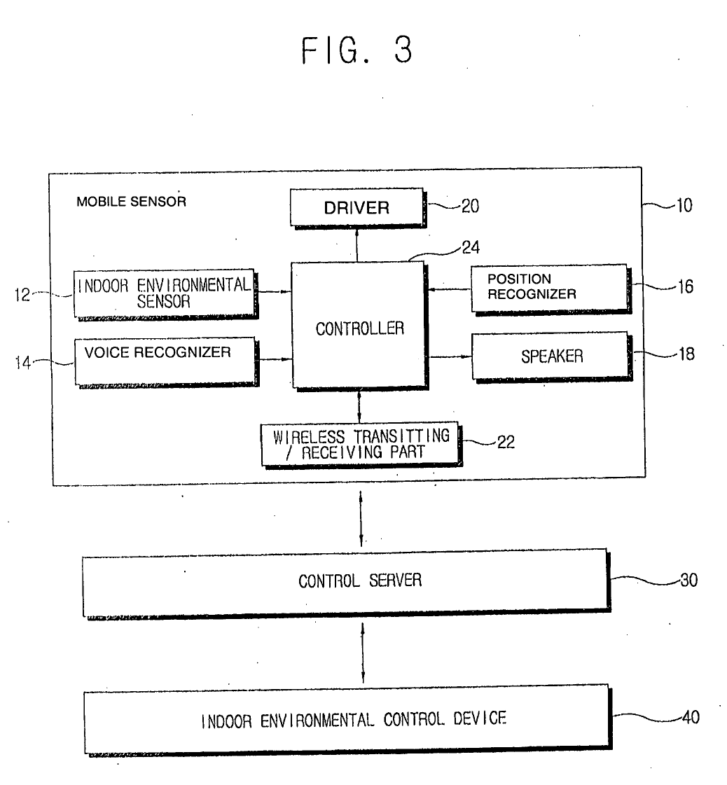

The home network for the indoor environment control system has a structure as shown in FIG. 2, wherein the control server 30 is connected with an access point 52 and a wireless transmitting/receiving part 22 (shown in FIG. 3) provided in the mobile sensor 10 wirelessly accesses the access point 52 connected with the control server 30, thereby accessing the home network.

The control server 30 is linked to the indoor environmental control device 40 by a power line communication (PLC) using a PLC gateway 50, thereby constructing the home network. The power line communication is a technology which has an access to high-speed Internet and transmits signals about voice and data such as a text and a picture over a power main. In the PLC, the power main at a home or an office is employed as both an electric power line and a communication line. Since the power mains have been laid at the home or the office, laying new cables to access the high-speed Internet is unnecessary.

However, the construction of the home network is not limited to the PLC. Instead, IEEE (Institute of Electrical and Electronic Engineers) 1394, Home PNA (Home Phoneline Networking Alliance) or Bluetooth, etc. may be used.

FIG. 3 is a control block diagram of the indoor environmental control system according to the present invention. In FIG. 3, the indoor environmental control system according to the present invention comprising an indoor environmental control device 40 to control the indoor environments, a mobile sensor 10 comprising a wireless transmitting/receiving part 22 having a wireless network accessing module such as a wireless LAN (local area network) card or the Bluetooth to wirelessly access the control server 30, a driver 20 to move the mobile sensor 10, a position recognizer 16 to recognize a position of itself, a voice recognizer 14 to recognize a voice command of a user, a speaker 18 to output sound, an indoor environmental sensor 12 to sense the indoor environments, and a controller 24 to control the above described components of the mobile sensor 10; and the control server 30 to control the indoor environmental control device 40 based on information transmitted from the mobile sensor 10.

The driver 20 drives a motor provided in the mobile sensor 10 to move the mobile sensor 10 in response to a control signal from the controller 24.

The position recognizer 16 comprising a video signal processing board (not shown) and a camera (not shown) to recognize the position of itself. The controller 24 controls the camera of the position recognizer 16 to take a photograph to recognize the position of itself in response to an input by a user, and controls the video signal processing board to process a video signal of the photograph transmitted from the camera. Then, the controller 24 analyzes the processed video signal and determines the position of the mobile sensor 10.

The voice recognizer 14 is provided with a voice recognition engine as a module. The voice recognizer 14 analyzes the voice command of a user through the voice recognition engine, creates a predetermined code based on the analyzed voice command, and transmits the code corresponding to the controller 24. The controller 24 transmits a control signal based on the received code to the control server 30, thereby controlling the indoor environmental control device 40 accessing the control server 30.

The controller 24 controls the speaker 18 to output a controlled result as a voice, wherein the controlled result is transmitted from the indoor environmental control device 40 to the mobile sensor 10 through the control server 30, thereby allowing a user to easily know the indoor environments.

The indoor environmental sensor 12 comprising a temperature sensor 12a and an air cleanness sensor 12b to sense the indoor environments such as temperature, humidity and air cleanness.

The controller 24 receives a position request command and an indoor environment request command from the control server 30, and periodically transmits information on its position analyzed by the position recognizer 16 and on the indoor environments sensed by the indoor environmental sensor 12 to the control server 30 through the wireless transmitting/receiving part 22. The controller 24 transmits information on real time to the control server 30.

Further, the controller 24 allows the control server 30 to control the indoor environmental control device 40 based upon the voice command of a user recognized by the voice recognizer 14. Thus, the indoor environmental control device 40 controls the indoor environments according to the voice command of a user.

The mobile sensor 10 further comprising an obstacle sensing part (not shown) to sense an obstacle to be moved. The obstacle sensing part comprising a video signal processing board (not shown) and a camera (not shown). In the obstacle sensing part, a video signal of a photograph taken by the camera is processed by the video signal processing board according to control of the controller 24. Thus, the controller 24 controls the driver 20 to operate based upon the processed video signal received from the video signal processing board of the obstacle sensing part, so that the mobile sensor 10 can cope with the obstacle.

The control server 30 receives the information on the position and on the indoor environments from the mobile sensor 10, and determines the indoor environments according to the positions based upon the information received from the mobile sensor 10. Thus, the control server 30 controls the indoor environmental control device 40 based upon the determined indoor environments.

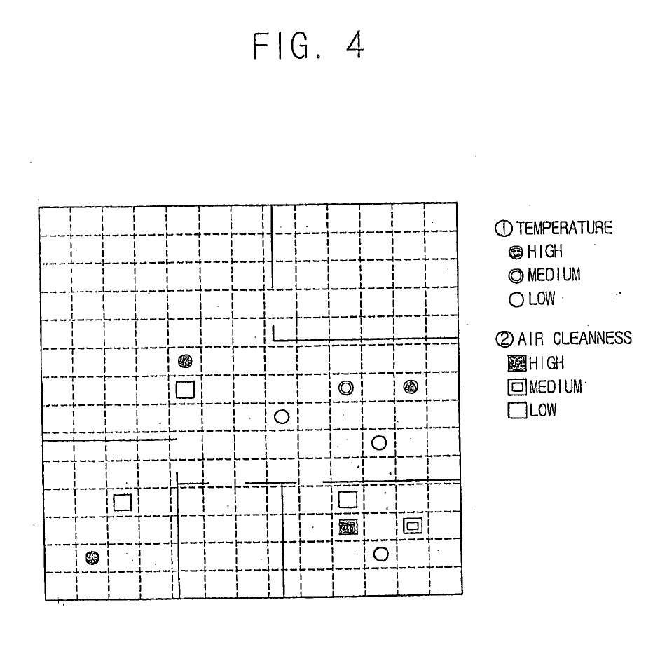

Determining the indoor environments according to the positions can be achieved by real-time estimate algorithm to estimate the real-time indoor environments, and a map divided by a lattice as shown in FIG. 4. For example, in the map of FIG. 4, a room is divided by a square lattice of imaginary lines, wherein the information on the indoor environments sensed in one lattice are the same.

When the control server 30 receives the information on the position and the indoor environments from more than a predetermined number of lattices, the control server 30 estimates the indoor environments based on the received information samples by using the real-time estimate algorithm.

There, at a place where the mobile sensor 10 cannot reach, the indoor environments can be estimated by using another algorithm considering elements such as heat transfer and air fluid mechanics.

When the control server 30 does not receives enough information on the position and the indoor environments, the control server 30 transmits a command to the mobile sensor 10 to move and further sense the indoor environments.

There, the control server 30 updates the map by using the real-time estimate algorithm based upon the information on the position and the indoor environments periodically received from the mobile sensor 10. Further, the control server 30 periodically transmits information on the map to the indoor environmental control device 40.

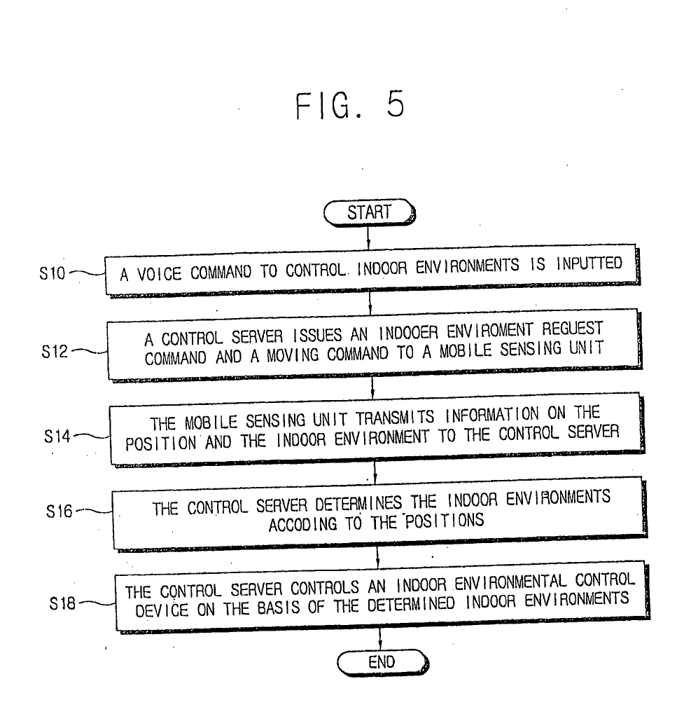

An operation of the indoor environmental control system according to the present invention will be described hereinbelow with reference to FIG. 5. At operation S10, when a user gives a command by a voice to control the indoor environments, the voice recognizer 14 of the mobile sensor 10 recognizes the voice command. Then, the controller 24 transmits the control signal corresponding to the recognized voice command to the indoor environmental control device 40 through the control server 30, and the indoor environmental control device 40 transmits its operating information to the control server 30. At operation S12 the control server 30 transmits an indoor environment request command and a moving command to the mobile sensor 10. Then, the controller 24 of the mobile sensor 10 controls the driver 20 to move the mobile sensor 10, and controls the indoor environmental sensor 12 to sense the indoor environments. At operation S14, the controller 24 transmits the information on the position and the indoor environments to the control server 30. At operation S16, the control server 30 determines the indoor environments according to the positions based upon the information on the positions and on the indoor environments received from the mobile sensor 10. Then, the map containing the information on the indoor environments is estimated. At operation S18, the control server 30 controls the indoor environmental control device 40 based upon the determined indoor environments. Thus, the indoor environments are optimized.

The control server may be added to the indoor environmental control device.

In the above-described embodiment, the mobile sensor 10 recognizes the position of itself, and transmits information on the recognized position to the control server 30. However, the control server may directly recognize the position of the mobile sensor 10.

The indoor environmental control device may be added to the mobile sensor 10.

Further, the indoor environmental control device may be turned on/off by the voice command of a user.

According to the present invention, the indoor environments are sensed by the mobile sensor 10, and the control server 30 controls the indoor environmental control device 40 by estimating the map based on the sensed indoor environments, wherein the map contains the information on the indoor environments according to the positions. Thus, the indoor environments can be optimized.

As described above, the present invention provides an indoor environment control system and a method of controlling the same, which can optimize indoor environments through a home network.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An indoor environmental control system having an indoor environmental control device to control at least one indoor environment, comprising:
a mobile sensor being movable, and comprising:
a wireless transmitting/receiving part to wirelessly transmit and receive information,
an indoor environmental sensor to sense the indoor environment, and
a controller to transmit the information on the indoor environment sensed by the indoor environmental sensor through the wireless transmitting/receiving part; and
a control server receiving the information transmitted from the mobile sensor so as to control the indoor environmental control device based upon the information received.

2. The indoor environmental control system of claim 1, wherein the indoor environment comprises at least one of temperature, humidity and air cleanness.

3. The indoor environmental control system of claim 1, wherein the mobile sensor further comprises a driver to move the mobile sensor.

4. The indoor environmental control system of claim 1, wherein the mobile sensor further comprises a position recognizer to recognize a position of itself, and
the controller transmits the information on the position recognized by the position recognizer and the information on the indoor environments sensed by the indoor environmental sensor to the control server through the wireless transmitting/receiving part.

5. The indoor environmental control system of claim 4, wherein the control server estimates a map based upon the information on the position and the information on the indoor environments received from the mobile sensor, and controls the indoor environmental control device to control the indoor environments based upon the estimated map.

6. The indoor environmental control system of claim 1, wherein the mobile sensor further comprises a voice recognizer to recognize a voice command of a user, and wherein the controller controls the indoor environmental control device to control the indoor environments according to the voice command recognized by the voice recognizer.

7. A method of controlling an indoor environmental control system having an indoor environmental control device to control at least one indoor environment, the method comprising:
sensing indoor environments according to positions; and
controlling the indoor environmental control device to control the indoor environments based on the sensed indoor environments.

8. The method of claim 7, wherein the indoor environment comprises at least one of temperature, humidity and air cleanness.

9. The method of claim 7, further comprising:
transmitting information on the sensed indoor environments according to the positions to a control server;
estimating a map containing the information on the indoor environments based upon the information received; and
controlling the indoor environmental control device to control the indoor environments based upon the estimated map.

10. The method of claim 7, further comprising:
recognizing a voice command of a user; and
controlling the indoor environmental control device to control the indoor environments according to the voice command recognized.

11. The indoor environmental control system of claim 1, wherein the mobile sensor is a mobile robot.

12. The indoor environmental control system of claim 1, wherein the mobile sensor, the indoor environmental control device and the control server are linked to each other through a home network.

13. The indoor environmental control system of claim 1, further comprising an access point, wherein the control server is connected with the access point and the wireless transmitting/receiving part wirelessly accesses the access point connected with the control server to access the home network.

14. The indoor environmental control system of claim 1, wherein the control server is linked to the indoor environmental control device by a power line communication.

15. The indoor environment control system of claim 4, wherein the position recognizer comprises:
a video signal processing board to process a video signal; and
a camera to recognize a position of itself, wherein:
the controller controls the camera of the position recognizer to take a photograph to recognize the position of itself in response to an input by a user,
controls the video signal processing board to process a video signal of the photograph transmitted from the camera, and
analyzes the video signal and determines the position of the mobile sensor.

16. The indoor environmental control system of claim 6, wherein the voice recognizer comprises a voice recognition engine and analyzes the voice command of the user through the voice recognition engine, creates a predetermined code based on the analyzed voice command, and transmits the code corresponding to the controller.

17. The indoor environmental control system of claim 16, wherein the controller transmits a control signal based on the received code to the control server and controls the indoor environmental control device accessing the control server.

18. The indoor environmental control system of claim 17, further comprising a speaker to output a controlled result as a voice, wherein the controlled result is transmitted from the indoor environmental control device to the mobile sensor through the control server.

19. The indoor environmental control system of claim 1, wherein the indoor environmental sensor comprising a temperature sensor and an air cleanness sensor to sense the indoor environments.

20. The indoor environmental control system of claim 3, wherein the mobile sensor further comprising an obstacle sensing part to sense an obstacle to be moved.

21. The indoor environmental control system of claim 20, wherein the obstacle sensing part comprising:
a video signal processing board to process a video signal; and
a camera, wherein the video signal of a photograph taken by the camera is processed by the video signal processing board and the controller controls the driver to operate based upon the processed video signal received from the video signal processing board of the obstacle sensing part to allow the mobile sensor to cope with the obstacle.

22. The indoor environmental control system of claim 5, wherein the map is divided by a plurality of square lattices and the information on the indoor environments sensed in one of the square lattice are the same.

23. The indoor environmental control system of claim 22, wherein the control server receives information on the position and the indoor environments from predetermined number of lattices and estimates the indoor environments based on the received information by using real-time estimate algorithm.

24. An indoor environmental control system comprising:
a mobile sensor being movable and comprising:
an indoor environmental sensor to sense the indoor environment, and
a controller to transmit the information on the indoor environment sensed by the indoor environmental sensor; and
an indoor environmental control device to control at least one indoor environment and comprising a control server to receive the information transmitted from the mobile sensor so as to control the indoor environmental control device based upon the information received.

25. The indoor environmental control system of claim 24, wherein the control server recognizes a position of the mobile sensor.

26. An indoor environmental control system comprising:
a mobile sensor being movable and comprising:
a wireless transmitting/receiving part to wirelessly transmit and receive information,
an indoor environmental sensor to sense the indoor environment,
a controller to transmit the information on the indoor environment sensed by the indoor environmental sensor through the wireless transmitting/receiving part, and
an indoor environment control device to control at least one indoor environment.

27. The indoor environmental control system of claim 26, wherein the indoor environmental control device may be turned on and off by a voice command of a user.
